(19) United States
(12) Patent Application Publication
(10) Pub. No.: US 2016/0026854 A1
(43) Pub. Date: Jan. 28, 2016

(54) METHOD AND APPARATUS OF IDENTIFYING USER USING FACE RECOGNITION

(71) Applicant: Samsung Electronics Co., Ltd., Suwon-si (KR)

(72) Inventors: Wonjun HWANG, Seoul (KR); Sungjoo SUH, Seoul (KR); Jungbae KIM, Seoul (KR); Jaejoon HAN, Seoul (KR)

(21) Appl. No.: 14/803,332

(22) Filed: Jul. 20, 2015

(30) Foreign Application Priority Data
Jul. 23, 2014 (KR) 10-2014-0093220

(51) Int. Cl. G06K 9/00; G06K 9/62

(52) U.S. Cl. CPC G06K 9/00221; G06K 9/6215

(57) ABSTRACT

At least one example embodiment discloses a user authentication method including acquiring representative reference images classified from a pre-stored first reference image of a user based on desired criteria, acquiring representative input images classified from a first input image based on the desired criteria, calculating a similarity between the first input image and the first reference image based on the representative input images and the representative reference images, and authenticating a user based on the calculated similarity.

### CROSS-REFERENCE TO RELATED APPLICATION

This application claims the priority benefit of Korean Patent Application No. 10-2014-0093220, filed on Jul. 23, 2014, in the Korean Intellectual Property Office, the disclosure of which is incorporated herein by reference in its entirety.

### BACKGROUND

1. Field

At least some example embodiments relate to a method and apparatus for identifying a user through a facial recognition.

2. Description of the Related Art

Currently, the importance of security is further growing with the occurrence of accidents, incidents, and criminal activity. Accordingly, many surveillance cameras have been installed and the number of surveillance cameras is increasing. In addition thereto, types of images and quantity of images stored in archives of security images are also increasing. Archive searching is used to find out a crime type and a criminal before and after the occurrence of an accident and an incident. However, it is not easy to conduct a quick search on images captured from a large number of cameras.

Accordingly, a method of conducting a search by verifying a feature of an image is used to quickly search for a desired situation or a desired image from among images stored in a large archive. When performing a facial recognition on images stored in the archive, the recognition performance is degraded due to a variation in a pose, a lighting, and a facial expression. Accordingly, it is not easily to apply a facial recognition function to a product.

In addition, a user authentication method using bio-information, for example, recognition of a fingerprint has been recently applied to a portable device. A separate hardware device capable of scanning a fingerprint of a user may be used to recognize the fingerprint. As an alternative, technology for recognizing a user using a user face through an imaging device such as a camera included in a portable device is under development.

As described above, many facial recognition algorithms are developed to identify a user by recognizing a face of the user. However, due to various poses of the user face and inconsistency in a color or brightness of a lighting at a location at which the user is present, it is difficult to accurately authenticate the user through the facial recognition.

### SUMMARY

At least one example embodiment relates to a user authentication method.

According to an example embodiment, a user authentication method includes acquiring representative reference images classified from a first reference image of a user based on desired criteria, acquiring representative input images classified from a first input image based on the desired criteria, calculating a similarity between the first input image and the first reference image based on the representative input images and the representative reference images, and authenticating a user based on the calculated similarity.

At least some example embodiments provide that the calculating calculates the similarity based on distances between features points of the representative input images and feature points of the representative reference images that correspond to each other based on the desired criteria.

At least some embodiments provide that the calculating calculates the similarity based on a distance between a feature point of the first input image and a feature point of the first reference image and distances between features points of the representative input images and feature points of the representative reference images that correspond to each other based on the desired criteria.

At least some example embodiments provide that the calculating calculates the similarity based on a distance between a feature point of the first input image and a feature point of the first reference image, distances between features points of the representative input images and feature points of the representative reference images that correspond to each other based on the desired criteria, and a weight of each of the distances between the features points of the representative input images and the feature points of the representative reference images.

At least some example embodiments provide that the acquiring the representative reference images may include classifying reference example sets from the first reference image, and acquiring the representative reference images for each reference example set classified from the first reference image based on the desired criteria.

At least some example embodiments provide that the acquiring the representative reference images may include classifying a plurality of reference example images similar to the first reference image into reference example sets based on the desired criteria through clustering, and creating the representative reference images based on the reference example images similar to the first reference image that are retrieved from each reference example set.

At least some example embodiments provide that the reference example images may include at least one of example images acquired from different poses of the user and example images acquired based on different lighting brightness, and the reference example images may be stored in an example image database.

Example embodiments provide that the acquiring the representative input images may include acquiring the representative input image for each input example set classified from the first input image based on the desired criteria.

At least some example embodiments provide that the acquiring of the representative input images may include classifying a plurality of input example images similar to the first input image into n input example sets based on the desired criteria through clustering, n denoting a natural number greater than or equal to “1”, and creating the n representative input images based on the first input example images similar to the first input image that are retrieved from each reference example set.

At least some example embodiments provide that the creating may include calculating a similarity between each of the n input example sets and the first input image, and determining m input example images having the similarity greater than a reference value, m denoting a natural number greater than or equal to “1”, and creating the n representative input images using the m input example images.

At least some example embodiments provide that the desired criteria may include a variation in a pose of a face or a variation in a lighting.

At least one example embodiment relates to a user authentication apparatus.

According to an example embodiment, a user authentication apparatus includes a storage configured to store a first reference image of a user, a communicator configured to receive first input image, and a processor configured to acquire representative reference images classified from the first reference image based on desired criteria, to acquire representative input images classified from the first input image based on the desired criteria, and to authenticate the user based on a similarity between the first input image and the first reference image that is based on the representative input images and the representative reference images.

At least some example embodiments provide that the processor may calculate the similarity based on distances between features points of the representative input images and feature points of the representative reference images that correspond to each other based on the desired criteria.

At least some example embodiments provide that the processor may calculate the similarity based on a distance between a feature point of the first input image and a feature point of the first reference image and distances between features points of the representative input images and feature points of the representative reference images that correspond to each other based on the desired criteria.

At least some example embodiments provide that the processor may calculate the similarity based on a distance between a feature point of the first input image and a feature point of the first reference image, distances between features points of the representative input images and feature points of the representative reference images that correspond to each other based on the desired criteria, and a weight of each of the distances between the features points of the representative input images and the feature points of the representative reference images.

At least some example embodiments provide that the processor may classify a plurality of reference example images similar to the first reference image into a plurality of reference example sets based on the desired criteria through clustering, and may create the representative reference images based on reference example images similar to the first reference image that are retrieved from each reference example set.

At least some example embodiments provide that the reference example images may include at least one of example images acquired from different poses of the user and example images acquired based on different lighting brightness, and the storage may include an example image database configured to store the reference example images.

At least some example embodiments provide that the processor may classify a plurality of input example images similar to the first input image into n input example sets based on the desired criteria through clustering, n denoting a natural number greater than or equal to “1,” and may create the n representative input images based on the input example images similar to the first input image that are retrieved from each reference example set.

At least one example embodiment relates to a user authentication apparatus.

According to an example embodiment, a user recognition method includes acquiring representative reference images classified from each of a plurality of first reference images of users based on desired criteria, acquiring representative input images classified from a first input image based on the predetermined and/or desired criteria, calculating a similarity between the first input image and each of the first reference images based on the representative input images and the representative reference images, and recognizing a user corresponding to the first input image from among the plurality of users based on the calculated similarity.

At least some example embodiments provide that the calculating may include calculating the similarity based on a distance between a feature point of the first input image and a feature point of each of the first reference images and distances between features points of the representative input images and feature points of the representative reference images that correspond to each other based on the predetermined and/or desired criteria.

At least some example embodiments provide that the calculating may include calculating the similarity based on a distance between a feature point of the first input image and a feature point of each of the first reference images, distances between features points of the representative input images and feature points of the representative reference images that correspond to each other based on the predetermined and/or desired criteria, and a weight of each of the distances between the features points of the representative input images and the feature points of the representative reference images.

At least some example embodiments provide that the acquiring of the representative reference images may include acquiring the representative reference images for each reference example set classified from each of the first reference images based on the predetermined and/or desired criteria.

At least some example embodiments provide that the acquiring of the representative reference images may include classifying a plurality of reference example images similar to each of the first reference images into a plurality of reference example sets based on the predetermined and/or desired criteria through clustering, and creating the representative reference images based on reference example images similar to each of the first reference images that are retrieved from each reference example set.

At least some example embodiments provide that the reference example images may include at least one of example images acquired from different poses of each of the users and example images acquired based on different lighting brightness, and the reference example images may be stored in an example image database.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects will become apparent and more readily appreciated from the following description of example embodiments, taken in conjunction with the accompanying drawings of which:

FIG. 1 illustrates a feature space used for a user authentication method using a facial recognition according to at least some example embodiments.

FIG. 2 illustrates a user authentication method using a facial recognition according to at least some example embodiments.

FIG. 3 illustrates a method of acquiring representative reference images in a user authentication method using a facial recognition according to at least some example embodiments.

FIG. 4 illustrates a method of acquiring representative input images in a user authentication method using a facial recognition according to at least some example embodiments.

FIG. 5 illustrates a method of acquiring representative input images in a user authentication method using a facial recognition according to at least some example embodiments.

FIG. 6 illustrates a method of retrieving input simple images similar to an input image in a user authentication method using a facial recognition according to at least some example embodiments.

FIG. 7 illustrates a method of creating representative input images in a user authentication method using a facial recognition according to at least some example embodiments.

FIG. 8 illustrates input example images similar to each input image in each input example set acquired from each pose and reference example images similar to a reference image in a user authentication method using a facial recognition according to at least some example embodiments.

FIG. 9 illustrates a simplified form of FIG. 8.

FIG. 10 illustrates representative input images created using input example images similar to an input image retrieved from each clustered input example set and weights of the input example images according to at least some example embodiments.

FIG. 11 illustrates a method of calculating a similarity between an input image and a reference image in a user authentication method using a facial recognition according to at least some example embodiments.

FIG. 12 illustrates a user authentication apparatus using a facial recognition according to at least some example embodiments.

FIG. 13 illustrates a user recognition method according to at least some example embodiments.

### DETAILED DESCRIPTION

Detailed illustrative embodiments are disclosed herein. However, specific structural and functional details disclosed herein are merely representative for purposes of describing example embodiments. Example embodiments may be embodied in many alternate forms and should not be construed as limited to only those set forth herein.

It should be understood, however, that there is no intent to limit this disclosure to the particular example embodiments disclosed. On the contrary, example embodiments are to cover all modifications, equivalents, and alternatives falling within the scope of the example embodiments. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of this disclosure. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Various example embodiments will now be described more fully with reference to the accompanying drawings in which some example embodiments are shown. In the drawings, the thicknesses of layers and regions are exaggerated for clarity.

A computer system is used as a single reference to describe example embodiments. Those skilled in the art may sufficiently understand that systems and methods described in the following are applicable to any display system including a user interface. In particular, a user authentication method and apparatus using a facial recognition disclosed herein may be implemented by a computer system including at least one processor, a memory, and a display device. As known to one skilled in the art, the computer system may be a portable device such as a cellular phone.

The terms “example embodiments,” “example,” “aspect,” “instance,” etc., used herein should not be interpreted that a predetermined and/or desired aspect or design is excellent or advantageous compared to other aspects or designs.

The terms “component,” “module,” “system,” “interface,” etc., used herein may indicate computer-related entities, for example, hardware, software, and a combination of hardware and software.

Also, the term “or” indicates “inclusive OR” rather than “exclusive OR”. That is, unless described otherwise, or unless the context clearly indicates otherwise, the expression that “x uses a or b” indicates one of natural inclusive permutations.

The terminology used herein is for the purpose of describing particular embodiments only and is not intended to be limiting. As used herein, the singular forms “a,” “an,” and “the,” are intended to include the plural forms as well, unless the context clearly indicates otherwise. Also, the terms “and/or” used herein should be understood to indicate and include all the possible combinations of at least one item among stated related items.

It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, example embodiments will be described with reference to the accompanying drawings. However, the present disclosure is not limited thereto or restricted thereby. Also, like reference numerals refer to like elements throughout.

Although a description is made hereinafter based on an example of using a facial image as an input image, an image acquired from a unique partial body of each user may be input as an image or an input image.

A user identification method described in the following may include a user authentication method for authenticating a single user or a limited number of users in a personalized device such as a mobile device, and a user recognition method for recognizing a specific user from among a plurality of users. The user authentication method and the user recognition method may be classified based on whether an input image is compared to a reference image of a single user, which corresponds to the user authentication method, or whether an input image is compared to reference images of a plurality of users, which corresponds to the user recognition method. However, the user authentication method and the user recognition method may differ based on example embodiments, and may operate in a similar manner. Hereinafter, a description will be made based on an example of the user authentication method.

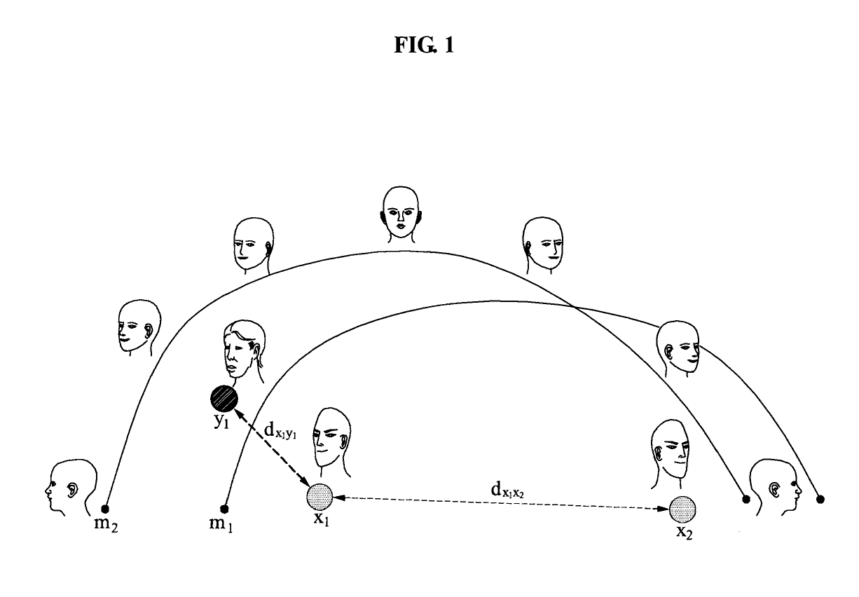

FIG. 1 illustrates a feature space used for a user authentication method using a facial recognition according to at least some example embodiments.

Referring to FIG. 1, different example images are projected onto the feature space with respect to faces of a plurality of users. The different example images may be variously transformed based on poses of users and lightings, and may be projected onto the feature space based on feature points of the example images.

Referring to FIG. 1, the different example images projected onto the feature space are represented based on feature points of the example images. For simple representation, it is assumed that a variation in a lighting is absent and only a variation in a pose of a user face is present.

In FIG. 1, a curved line m₁ indicates locations of example images transformable from an input image of a user A in the feature space, and a curved line m₂ indicates locations of example images transformable from an input image of a user B. x₁ and x₂ indicate feature points of a face according to a variation in a pose of the same user C, and y₁ indicates a feature point of a face of a user D.

A distance between x₁ and x₂ that are feature points of facial images acquired from different poses of the same user C may be calculated as “dx₁x₂” according to Euclidean distance equation “L2 distance”. A distance between x₁ and y₁ that are feature points of facial images acquired from similar poses of different users C and D may be calculated as “dx₁y₁” according to the Euclidean distance equation “L2 distance”.

The relationship dx₁y₁>dx₁x₂ is used to accurately perform the user authentication using the facial recognition in the feature space. However, in reality, dx₁y₁<<dx₁x₂ may occur as illustrated in FIG. 1. Such a result is acquired since, in the user authentication method using the facial recognition, it is difficult to linearly learn images transformable based on a variation in a pose. That is, facial images acquired from the same pose of different users may appear to be further similar in the feature space compared to facial images acquired from different poses of the same user.

Hereinafter, the term “distance” may be understood as a distance between features or feature points in the feature space.

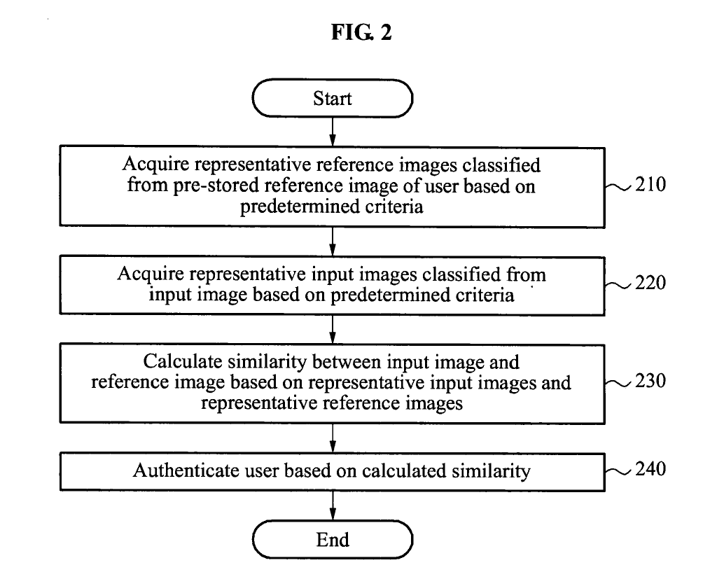

FIG. 2 illustrates a user authentication method using a facial recognition according to at least some example embodiments.

Referring to FIG. 2, in operation 210, a user authentication apparatus (hereinafter, an authentication apparatus) may acquire representative reference images classified from a pre-stored reference image of a user based on predetermined and/or selected (or desired) criteria. Here, the predetermined and/or selected criteria may include a variation in a pose of a face or a variation in a lighting.

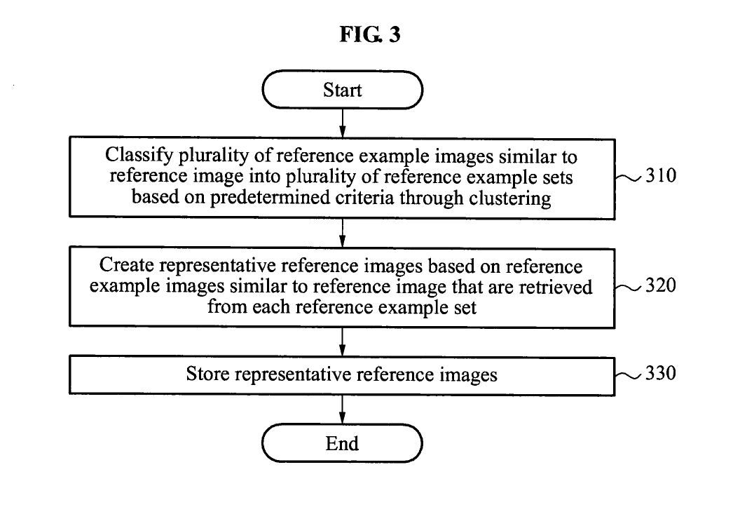

In operation 210, the authentication apparatus may acquire the representative reference images for each reference example set classified from the reference image based on the predetermined and/or selected criteria. A method of acquiring, by the authentication apparatus, representative reference images will be described with reference to FIG. 3.

In operation 220, the authentication apparatus may acquire representative input images classified from an input image based on the predetermined and/or selected criteria. Here, the input image may be, for example, an image captured through an image sensor or a camera included in the authentication apparatus. The input image may include a facial image of a user, and may relate to a single user or a plurality of users.

In operation 220, the authentication apparatus may acquire the representative input image for each input example set classified from the input image based on the predetermined and/or selected criteria.

In operation 230, the authentication apparatus may calculate a similarity between the input image and the reference image based on the representative input images and the representative reference images.

In operation 230, the authentication apparatus may calculate the similarity based on distances between features points of the representative input images and feature points of the representative reference images that correspond to each other based on the predetermined and/or selected criteria.

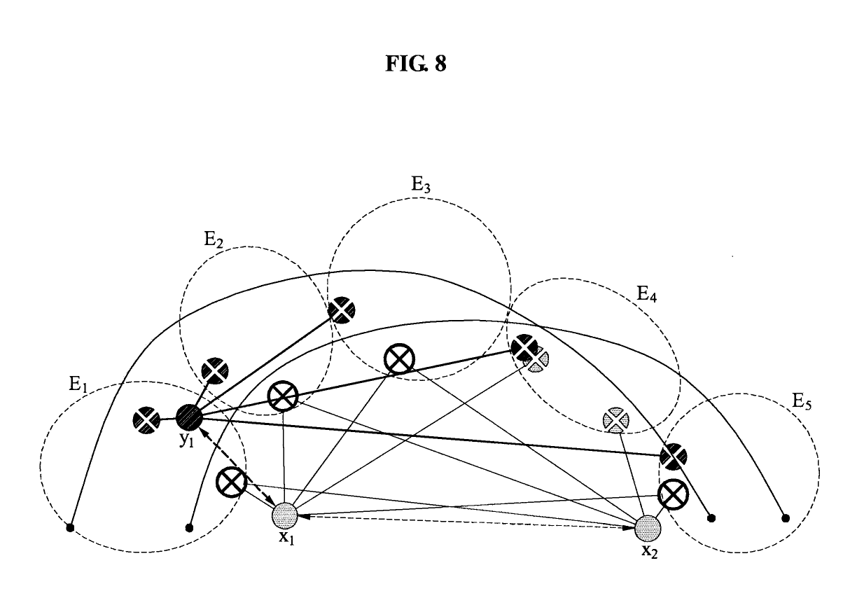

Also, the authentication apparatus may calculate the similarity based on a distance between a feature point of the input image and a feature point of the reference image and distances between features points of the representative input images and feature points of the representative reference images that correspond to each other based on the predetermined and/or selected criteria. A method of calculating, by the authentication apparatus, a similarity between an input image and a reference image according to example embodiments will be described with reference to FIGS. 8, 9, and 11.

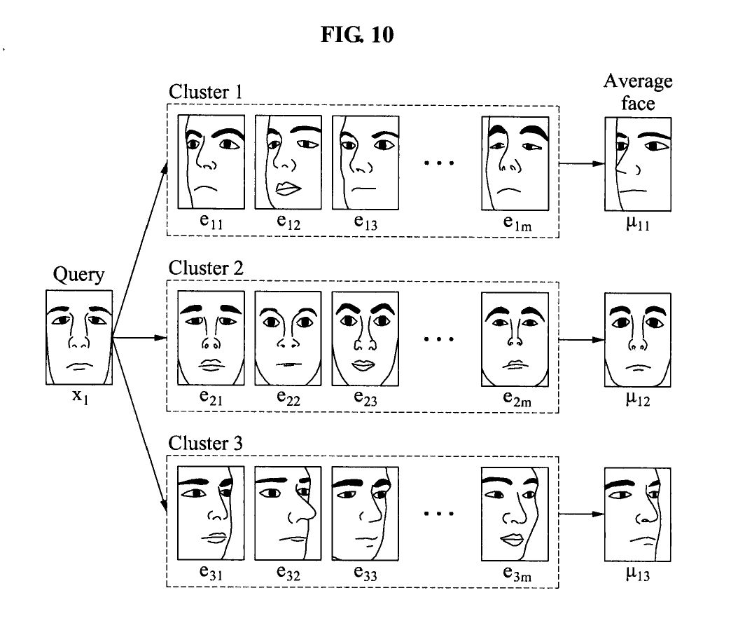

Also, the authentication apparatus may calculate the similarity based on a distance between a feature point of the input image and a feature point of the reference image, distances between features points of the representative input images and feature points of the representative reference images that correspond to each other based on the predetermined and/or selected criteria, and a weight of each of the distances between the features points of the representative input images and the feature points of the representative reference images. A method of calculating a similarity between an input image and a reference image by further using a weight according to example embodiments will be described with reference to FIG. 10.

In operation 240, the authentication apparatus may authenticate a user based on the calculated similarity. For example, when the calculated similarity is greater than or equal to a predetermined and/or selected value, the authentication apparatus may determine that a user of the input image is the same as a user of the reference image.

FIG. 3 illustrates a method of acquiring representative reference images in a user authentication method using a facial recognition according to at least some example embodiments.

Referring to FIG. 3, in operation 310, the authentication apparatus may classify a plurality of reference example images similar to the reference image into a plurality of reference example sets based on the predetermined and/or selected criteria through clustering. Here, the reference image may be pre-stored in a storage of the authentication apparatus. The reference example images may include at least one of example images acquired from different poses of the user and example images acquired based on different lighting brightness.

The reference example images may be pre-stored in an example image database. The example image database may be stored in the storage or separate storage media.

In operation 320, the authentication apparatus may create the representative reference images based on reference example images similar to the reference image that are retrieved from each reference example set.

In operation 330, the authentication apparatus may store the created representative reference images in the storage. The authentication apparatus may pre-store the acquired representative reference images in the example image database, and may call and use the stored representative reference images in response to an input of an input image.

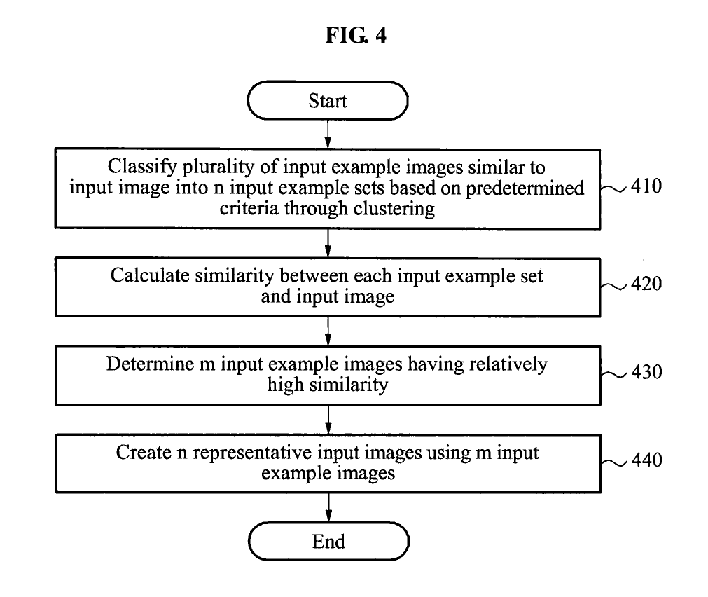

FIG. 4 illustrates a method of acquiring representative input images in a user authentication method using a facial recognition according to example embodiments.

Referring to FIG. 4, in operation 410, the authentication apparatus may classify a plurality of input example images similar to the input image into n input example sets based on the predetermined and/or selected criteria through clustering. Here, n denotes a natural number greater than or equal to “1”. The predetermined and/or selected criteria may include, for example, a variation in a pose of a face or a variation in a lighting.

The plurality of input example images may be, for example, 100 to 200, and input example sets may be, for example, 3 to 5.

In operation 410, the authentication apparatus may classify, into the input example sets, for example, example images acquired from different poses or example images acquired based on different lighting brightness through clustering.

The authentication apparatus may create the n representative input images based on the input example images similar to the input image that are retrieved from each reference example set.

In detail, in operation 420, the authentication apparatus may calculate a similarity between the input image and each of input example images similar to the input image in each of the n input example sets.

In operation 430, the authentication apparatus may determine m input example images having the similarity greater than a predetermined and/or selected reference value. Here, m denotes a natural number greater than or equal to “1”.

In operation 440, the authentication apparatus may create the n representative input images using the m input example images. The authentication apparatus may create and acquire a representative input image for each input example set.

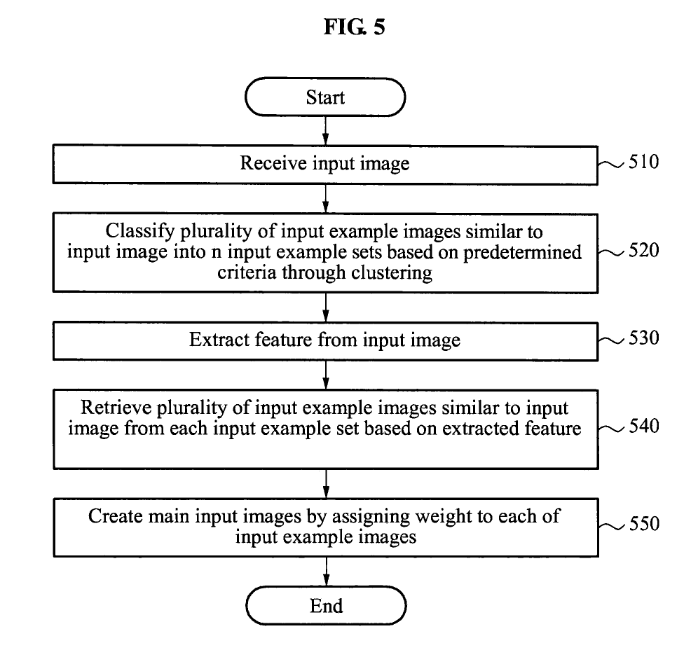

FIG. 5 illustrates a method of acquiring representative input images in a user authentication method using a facial recognition according to at least some example embodiments.

Referring to FIG. 5, in operation 510, the authentication apparatus may receive an input image.

In operation 520, the authentication apparatus may classify a plurality of input example images similar to an input image into n input example sets based on the predetermined and/or selected criteria through clustering. The plurality of input example images similar to the input image may be stored in, for example, an example image database. In operation 520, the plurality of input example images may be clustered based on a pose of a face or a lighting.

In operation 530, the authentication apparatus may extract a feature from the input image.

For example, in operation 530, the authentication apparatus may normalize input images to images having three landmarks and a predetermined and/or selected size, and may extract features from the normalized images. The three landmarks may be, for example, eyes, nose, and lips.

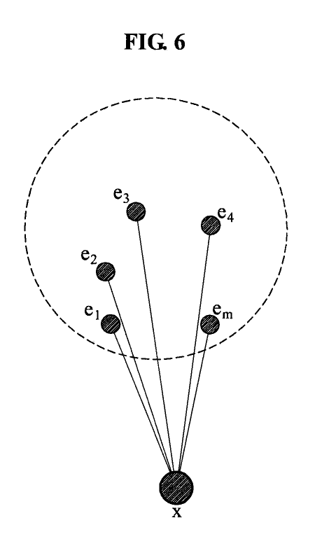

In operation 540, the authentication apparatus may retrieve the plurality of input example images similar to the input image from each input example set, using the feature extracted from the input image. In operation 540, the authentication apparatus may retrieve the plurality of input example images similar to the input image, based on a distance between the plurality of input example images projected onto a feature space based on the feature extracted from the input image. A method of retrieving a plurality of input example images similar to an input image will be described with reference to FIG. 6.

In operation 550, the authentication apparatus may create representative input images by applying a weight to each of the plurality of input example images similar to the input image that is retrieved in operation 540.

In operation 550, the authentication apparatus may create the representative input images by assigning a different weight based on a distance between the input image and each of the input example images similar to the input image.

FIG. 6 illustrates a method of retrieving input simple images similar to an input image in a user authentication method using a facial recognition according to at least some example embodiments.

Referring to FIG. 6, a single input example set includes input example images e₁, e₂, e₃, e₄, . . . , and eₘ similar to an input image x.

For example, it is assumed herein that the authentication apparatus retrieves m input example images e₁, e₂, e₃, e₄, . . . , and eₘ similar to the input image x from an input example set including different input example images of a user.

The authentication apparatus may cluster the input example images into n groups using a clustering method, for example, a K-means method. Here, the authentication apparatus may cluster input example images for each of five poses, for example, −120 degrees, −60 degrees, 0 degrees, +60 degrees, and +120 degrees, or each of seven poses, for example, −45 degrees, −30 degrees, −15 degrees, 0 degrees, +15 degrees, +30, and +45 degrees.

In response to an input of the input image x, the authentication apparatus may extract a feature from the input image x, and may retrieve the input example images e₁, e₂, e₃, e₄, . . . , and eₘ similar to the input image x using the extracted feature.

The authentication apparatus may retrieve the respective m input example images similar to the input image x based on the feature extracted from the input image x, from the input example set including different example images of the user.

For example, in the feature space of FIG. 6, the authentication apparatus may retrieve the input example images e₁, e₂, e₃, e₄, . . . , and eₘ similar to the input image x based on a distance between input example images based on the feature extracted from the input image x.

The authentication apparatus may retrieve m input example images similar to the input image x per variation of a face, that is, with respect to each of the n input example sets.

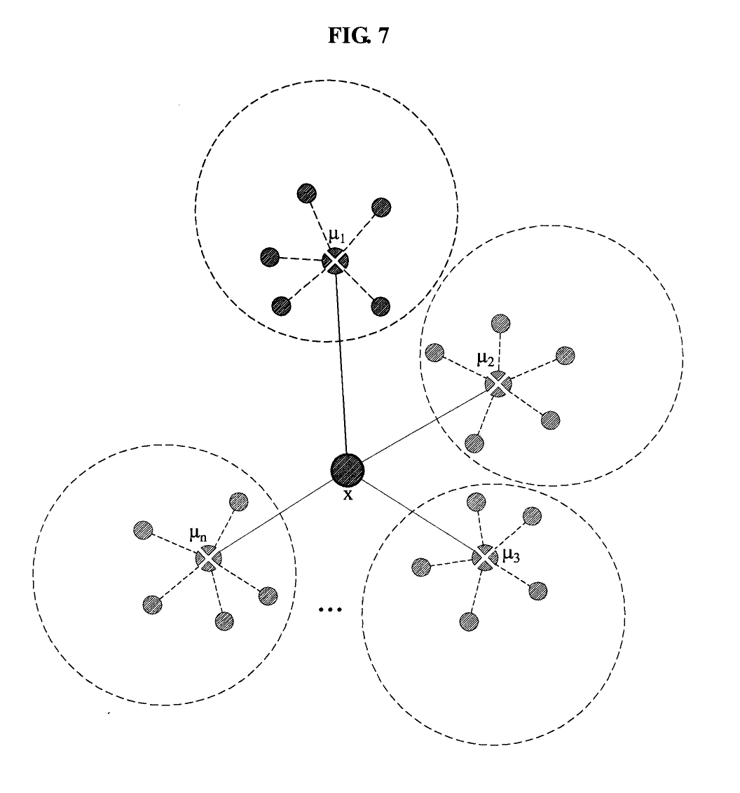

FIG. 7 illustrates a method of creating representative input images in a user authentication method using a facial recognition according to at least some example embodiments.

Referring to FIG. 7, a feature or a feature point of a representative input image created from each of n input example sets is present. Although a method of creating representative input images from an input image is described in the following, the following method may be applicable to a case of creating representative reference images from a reference image.

When m input example images similar to an input image x are retrieved from each of the n input example sets, the authentication apparatus may create representative input images μ₁, μ₂, μ₃, . . . , and μₙ with respect to the n input example sets, respectively, based on the m input example images.

For example, it is assumed herein that five input example images similar to the input image x are retrieved from a first input example set clustered with respect to a pose rotated to the right by 45 degrees, that is, +45 degrees based on a front.

In this example, the authentication apparatus may create the representative input image μ₁ of the first input example set using the five similar input example images. Here, when a total of seven input example sets are clustered for each pose, the authentication apparatus may create representative input images μ₁, μ₂, μ₃, . . . , and μ₇ with respect to the seven input example sets, respectively. In this example, the representative input image may be an average input image acquired by averaging feature points of the five input example images similar to the input image in each input example set.

Here, feature vectors extracted from representative input images with respect to the seven input example sets may be complementary. The input example images may be grouped based on a facial feature through clustering. For example, when seven poses, such as −45 degrees, −30 degrees, −15 degrees, 0 degrees, +15 degrees, +30 degrees, and +45 degrees, are present, the input example images may be grouped into input example sets of the seven poses.

Here, a representative input image created from each cluster may apply a characteristic of a corresponding input example set, and different pose information may be present for each input example set. A representative input image created for each input example set may have a different characteristic. However, since a representative input image is configured using input example images similar to the input image, representative input images may be most similar to the input image, however, may have different feature values and may be complementary when performing a user authentication using a facial recognition.

Input example images similar to the input image x may be retrieved based on brightness of a lighting instead of using different poses.

For example, it is assumed herein that five input example images similar to the input image x are retrieved from a first input example set clustered with respect to 45 Lux of a lighting.

In this example, the authentication apparatus may create the representative input image μ₁ of the first input example set using the five similar input example images. Here, when a total of seven input example sets are clustered for each lighting brightness, the authentication apparatus may create representative input images μ₁, μ₂, μ₃, . . . , and μ₇ for the seven input example sets, respectively. In this example, the representative input image may be an average input image acquired by averaging feature points of the five input example images similar to the input image in each input example set.

Here, feature vectors extracted from representative input images with respect to the seven input example sets may be complementary. The input example images may be grouped based on a facial feature through clustering. For example, when different three lighting brightness, such as 10 Lux, 30 Lux, and 50 Lux, are present, the input example images may be grouped into input example sets of the three lighting brightness.

Here, a representative input image created from each cluster may apply a characteristic of a corresponding input example set, and different lighting brightness information may be present for each input example set.

FIG. 8 illustrates input example images similar to each of input images x₁ and y₁ in each input example set acquired from each pose and reference example images similar to a reference image x₂ in a user authentication method using a facial recognition according to at least some example embodiments.

Referring to FIG. 8, five input example sets E₁, E₂, E₃, E₄, and E₅ clustered from an example image database, the input images x₁ and y₁, and the reference image x₂ are illustrated.

Here, x₁ denotes the input image including a face of a user x, x₂ denotes a facial image of the user x pre-stored for facial recognition, that is, the reference image, and y₁ denotes the input image including a face of a user y different from the user x.

Here, the example image database may include input example images for each of different poses of the users x and y. The reference image x₂ and example images for each of different poses of the reference image x₂ may be pre-stored. The clustered five input example sets E₁, E₂, E₃, E₄, and E₅ may be clustered based on different poses or different lightings.

Hereinafter, a relationship between an input image and a reference image with respect to the same user, for example, the user x, will be described prior to describing input example images of a plurality of users.

The authentication apparatus may retrieve input example images similar to the input image x₁ from each of the five input example sets E₁, E₂, E₃, E₄, and E₅. The authentication apparatus may retrieve reference example images similar to the reference image x₂ from each of the five groups E₁, E₂, E₃, E₄, and E₅ through a process similar to the input image x₁.

Here, when the input image x₁ and the reference image x₂ are images of the same user x, images retrieved by the authentication apparatus as example images similar to each image, for example, the input image x₁ and the reference image x₂ may be the same example images. In FIG. 8, when the authentication apparatus retrieves the same example image with respect to the same user, the retrieved example image may be indicated as a node, [symbol] indicated with X within a black circle.

When images retrieved by the authentication apparatus as example images similar to each image, for example, the input image x₁ and the reference image x₂ are the same example images, the authentication apparatus may determine that the input image x₁ and the reference image x₂ are images of the same user.

Referring to the input example set E₄, although example images are not images of the same user x, the example images may be present within similar distances. That is, even in the case of the input image y₁ of the user y different from the user x, example images similar to the reference image x₂ may be retrieved from each of the input example sets E₁, E₂, E₃, E₄, and E₅.

For example, in an input example set for a pose at which a user glazes at the right side, example images of the input image y₁, for example, an input facial image of the user y may be located at distances similar to locations of the example images similar to the input image x₁ of the user x.

According to at least some example embodiments, distances between feature points of representative input images created from an input image and feature points of representative reference images created from a reference image may be used when calculating a similarity between the input image and the reference image. Accordingly, referring to FIG. 8, a distance between the input image x₁ and the reference image x₂ that are images of the same user may appear to be relatively close compared to a distance between the input image x₁ and the input image y₁ that are images of different users.

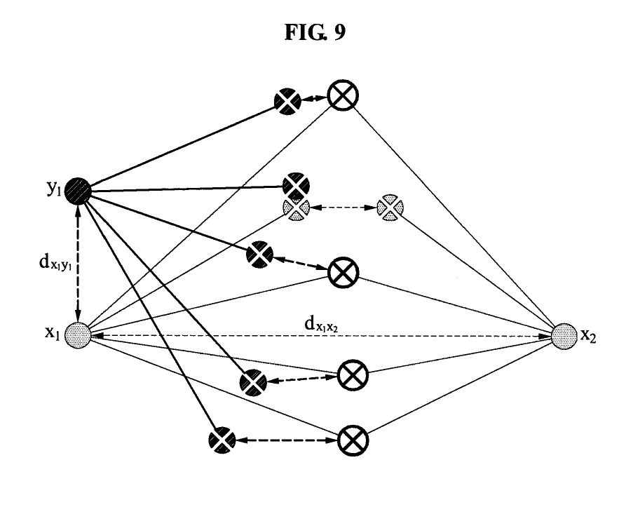

FIG. 9 illustrates a simplified form of FIG. 8.

In a feature space, relationships among a distance between the input image x₁ and the reference image x₂, a distance between example images similar to each of the input image x₁ and the reference image x₂, a distance between the input image x₁ and the input image y₁, and a distance between example images similar to each of the input image x₁ and the input image y₁ may be expressed by Equation 1.

dₓ_{₁}_{y}_{₁}+eₓ_{₁}_{y}_{₁}>dₓ_{₁}ₓ_{₂}+eₓ_{₁}ₓ_{₂} [Equation 1]

In Equation 1, dₓ_{₁}_{y}_{₁} denotes the distance between the input image x₁ and the input image y₁ in the feature space and eₓ_{₁}_{y}_{₁} denotes the average distance between example images similar to each of the input image x₁ and the input image y₁. Also, dₓ_{₁}ₓ_{₂} denotes the distance between the input image x₁ and the reference image x₂ and eₓ_{₁}ₓ_{₂} denotes the average distance between example images similar to each of the input image x₁ and the reference image x₂.

In FIG. 8, dₓ_{₁}_{y}_{₁}<dₓ_{₁}ₓ_{₁}. However, when using a distance between example images similar to each of the input image x₁ and the reference image x₂, a distance between images of the same user may appear to be relatively close as expressed by Equation 1. That is, a similarity between the input image x₁ and the reference image x₂ may appear to be relatively high.

Even in the case of a face of the same user, for example, a pose may vary. In this example, when using only a distance between feature points of a facial image acquired from a different pose, a similarity may be induced to be relatively low.

According to at least some example embodiments, representative input images may be created from input example sets for each of various poses classified from an input image, and representative reference images may be created from reference example sets for each of the various poses from a pre-stored reference image. Here, a similarity between facial images of the same user may be enhanced by using distances between feature points of the created representative input images and feature points of the created representative reference images and a distance between a feature point of the input image and a feature point of the reference image.

Here, distances between the feature points of the representative input images and the feature points of the representative reference images may be distances between feature points of the representative input images and feature points of the representative reference images that correspond to each other based on predetermined and/or selected criteria. For example, the authentication apparatus may calculate the similarity based on a distance between feature points, such as a distance between a representative input image and a representative reference image with respect to a first pose and a distance between a representative input image and a representative reference image with respect to a second pose.

In a feature space, a distance between an input image and a reference image may be referred to as a “global distance”. A distance between the input image and each of example images similar to the input image and a distance between the reference image and each of example images similar to the reference image may be referred to as a “local distance”. The local distance may be limited to a local feature space called a single set and may mitigate a distortion occurring in the feature space due to intra-variations.

According to example embodiments, it is possible to enhance the facial recognition performance using distances of different concepts, for example, the global distance and the local distance.

FIG. 10 illustrates representative input images created using input example images similar to an input image retrieved from each clustered input example set and weights of the input example images according to example embodiments.

Referring to FIG. 10, three representative input images μ₁₁, μ₁₂, and μ₁₃ are created using input example images e₁₁, e₁₂, e₁₃, . . . , e₁ₘ, e₂₁, e₂₂, e₂₃, . . . , e₂ₘ, e₃₁, e₃₂, e₃₃, . . . , and e₃ₘ similar to an input image x₁ that are retrieved from three clustered input example sets and weights of the input example images.

Rank orders between input example images are important for a facial recognition when creating representative input images.

For example, when retrieving a facial image most similar to an input image from a single input example set and sorting the facial image based on a rank order, a relatively high rank is assigned to an input example image most similar to the input image.

When an image significantly similar to an input image is included in input example images, using an input example image corresponding to another pose of the image significantly similar to the input image may be advantageous to perform a user authentication rather than using an input example image dissimilar to the input image. Accordingly, a relatively high weight may be assigned to a relatively high ranking input example image.

When using only a relatively high ranking example image, a similarity between the input image and representative input images may be enhanced. Many input example images may be matched in rank orders.

When creating representative input examples, the authentication apparatus may apply a different weight with respect to a distance from a query based on a rank order. Here, the query may be understood as the input image.

The authentication apparatus may create representative input images by applying different weights to distances between the input image and example images similar to the input image.

For example, a method of creating a representative input image μ₁ by applying a weight may be expressed by Equation 2.

$${μ}_{1} = {\sum }_{i} {w}_{i} {e}_{i} \qquad [ Equation 2 ]$$

In Equation 2,

$${\sum }_{i} {w}_{i} = 1 ,$$

wᵢ denotes a weight of each input example image, and eᵢ denotes a distance between the input image and each of input example images similar to the input image.

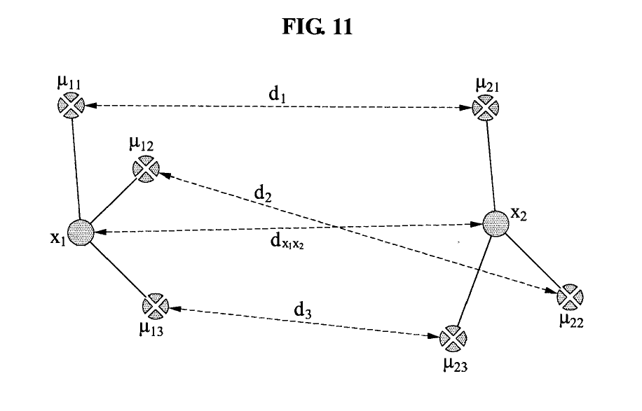

FIG. 11 illustrates a method of calculating a similarity between an input image and a reference image in a user authentication method using a facial recognition according to example embodiments.

In FIG. 11, x₁ denotes an input image and x₂ denotes a reference image. μ₁₁, μ₁₂, and μ₁₃ denote representative input images created using example images similar to an input image x₁ from input example sets 1, 2, and 3, respectively, and μ₂₁, μ₂₂, and μ₂₃ denote representative reference images created using example images similar to a reference image x₂ from groups 1, 2, and 3, respectively.

In addition, dₓ_{₁}ₓ_{₂} denotes a distance between the input image x₁ and the reference image x₂ in the feature space, d₁ denotes a distance between a feature point of the representative input image μ₁₁ and a feature point of the representative reference image μ₂₁, d₂ denotes a distance between a feature point of the representative input image μ₁₂ and a feature point of the representative reference image μ₂₂, and d₃ denotes a distance between a feature point of the representative input image μ₁₃ and a feature point of the representative reference image μ₂₃.

A method of calculating a similarity d between the input image x₁ and the reference image x₂ based on distances between features points calculated as above may be expressed by Equation 3.

$$d = {d}_{{x}_{1} {x}_{2}} + {\sum }_{i} {w}_{i} {d}_{i} \qquad [ Equation 3 ]$$

In Equation 3, wᵢ denotes a weight to be applied to each of representative images, and dᵢ denotes a distance between a feature point of a representative input image and a feature point of a representative reference image in each input example set.

The authentication apparatus may extract feature points of representative input images and feature points of representative reference images, and may calculate the similarity d by using a value in which a weight is applied to each of the representative input images and the representative reference images in the feature space, and a distance dₓ_{₁}ₓ_{₂} between the input image x₁ and the reference image x₂.

Here, in addition to a similarity between an input image and a reference image, a similarity between representative input images and representative reference images may also be used as an index to perform a facial recognition.

The aforementioned user authentication method may be used to recognize a user of the input image from among a plurality of users when pre-stored reference images are not images of a single user but images of each of the plurality of users.

That is, the user of the input image may be recognized from among users x, y, z, and 2 by pre-storing reference images of others users y, z, and w in addition to the user x, and by calculating a similarity between the input image and each of the reference images.

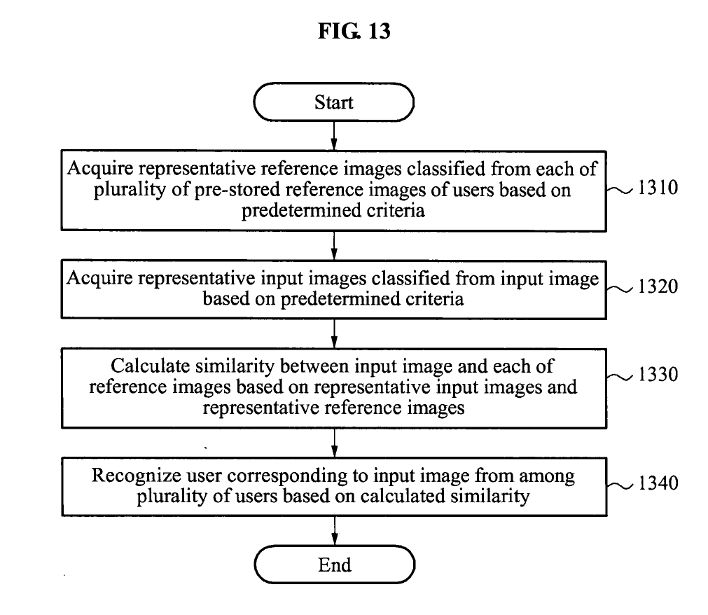

A method of recognizing a user using reference images of a plurality of users will be described with reference to FIG. 13.

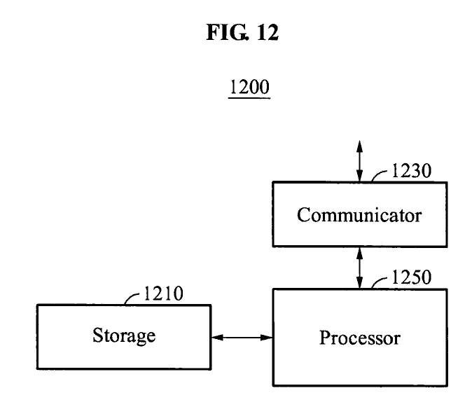

FIG. 12 illustrates a user authentication apparatus using a facial recognition according to example embodiments.

Referring to FIG. 12, an authentication apparatus 1200 includes a storage 1210, a communicator 1230, and a processor 1250.

The storage 1210 may store a reference image of a user.

The communicator 1230 may receive an input image. Here, a single input image or a plurality of input images may be received.

The processor 1250 may acquire representative reference images classified from the reference image based on predetermined and/or selected criteria, and may acquire representative input images classified from the input image based on the predetermined and/or selected criteria. The processor 1250 may authenticate the user based on a similarity between the input image and the reference image that is calculated based on the representative input images and the representative reference images.

The processor 1250 may calculate the similarity based on distances between features points of the representative input images and feature points of the representative reference images that correspond to each other based on the predetermined and/or selected criteria.

The processor 1250 may calculate the similarity based on a distance between a feature point of the input image and a feature point of the reference image and distances between features points of the representative input images and feature points of the representative reference images that correspond to each other based on the predetermined and/or selected criteria.

The processor 1250 may calculate the similarity based on a distance between a feature point of the input image and a feature point of the reference image, distances between features points of the representative input images and feature points of the representative reference images that correspond to each other based on the predetermined and/or selected criteria, and a weight of each of the distances between the features points of the representative input images and the feature points of the representative reference images.

The processor 1250 may classify a plurality of reference example images similar to the reference image into a plurality of reference example sets based on the predetermined and/or selected criteria through clustering. The processor 1250 may create the representative reference images based on reference example images similar to the reference image that are retrieved from each reference example set.

The reference example images may include at least one of example images acquired from different poses of the user and example images acquired based on different lighting brightness.

The storage 1210 may include an example image database configured to store the reference example images.

The processor 1250 may classify a plurality of input example images similar to the input image into n input example sets based on the predetermined and/or selected criteria through clustering. Here, n denotes a natural number greater than or equal to “1.” The processor 1250 may create the n representative input images based on the input example images similar to the input image that are retrieved from each reference example set.

FIG. 13 illustrates a user recognition method according to example embodiments.

Referring to FIG. 13, in operation 1310, a recognition apparatus according to example embodiments may acquire representative reference images classified from each of a plurality of pre-stored reference images of users based on predetermined and/or selected criteria. The recognition apparatus may be configured to be in substantially the same configuration as the authentication apparatus of FIG. 12.

In operation 1310, the recognition apparatus may acquire the representative reference images for each reference example set classified from each of the reference images based on the predetermined and/or selected criteria.

In operation 1310, the recognition apparatus may classify a plurality of reference example images similar to each of the reference images into a plurality of reference example sets based on the predetermined and/or selected criteria through clustering. The recognition apparatus may create the representative reference images based on reference example images similar to each of the reference images that are retrieved from each reference example set.

The reference example images may include at least one of example images acquired from different poses of each of the users and example images acquired based on different lighting brightness. The reference example images may be pre-stored in, for example, an example image database.

In operation 1320, the recognition apparatus may acquire representative input images classified from an input image based on the predetermined and/or selected criteria.

In operation 1330, the recognition apparatus may calculate a similarity between the input image and each of the reference images based on the representative input images and the representative reference images.

In operation 1330, the recognition apparatus may calculate the similarity based on a distance between a feature point of the input image and a feature point of each of the reference images and distances between features points of the representative input images and feature points of the representative reference images that correspond to each other based on the predetermined and/or selected criteria.

In operation 1330, the recognition apparatus may calculate the similarity based on a distance between a feature point of the input image and a feature point of each of the reference images, distances between features points of the representative input images and feature points of the representative reference images that correspond to each other based on the predetermined and/or selected criteria, and a weight of each of the distances between the features points of the representative input images and the feature points of the representative reference images.

In operation 1340, the recognition apparatus may recognize a user corresponding to the input image from among the plurality of users based on the calculated similarity.

The above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The non-transitory computer-readable media may also be a distributed network, so that the program instructions are stored and executed in a distributed fashion. The program instructions may be executed by one or more processors. The non-transitory computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

Although example embodiments have been shown and described, it would be appreciated by those skilled in the art that changes may be made in these example embodiments without departing from the principles and spirit of the disclosure, the scope of which is defined by the claims and their equivalents.

What is claimed is:

1. A user authentication method comprising:
acquiring representative reference images classified from a first reference image of a user based on desired criteria;
acquiring representative input images classified from a first input image based on the desired criteria;
calculating a similarity between the first input image and the first reference image based on the representative input images and the representative reference images; and
authenticating a user based on the calculated similarity.

2. The method of claim 1, wherein the calculating calculates the similarity based on distances between features points of the representative input images and feature points of the representative reference images that correspond to each other based on the desired criteria.

3. The method of claim 1, wherein the calculating calculates the similarity based on a distance between a feature point of the first input image and a feature point of the first reference image and distances between features points of the representative input images and feature points of the representative reference images that correspond to each other based on the desired criteria.

4. The method of claim 1, wherein the calculating calculates the similarity based on a distance between a feature point of the first input image and a feature point of the first reference image, distances between features points of the representative input images and feature points of the representative reference images that correspond to each other based on the desired criteria, and a weight of each of the distances between the features points of the representative input images and the feature points of the representative reference images.

5. The method of claim 1, wherein the acquiring the representative reference images comprises:
classifying reference example sets from the first reference image; and
acquiring the representative reference images for each reference example set classified from the first reference image based on the desired criteria.

6. The method of claim 5, wherein the acquiring the representative reference images comprises:
classifying a plurality of reference example images similar to the first reference image into reference example sets based on the desired criteria through clustering; and
creating the representative reference images based on first reference example images similar to the first reference image that are retrieved from each reference example set.

7. The method of claim 6, wherein
the reference example images include at least one of example images acquired from different poses of the user and example images acquired based on different lighting brightness, and
the reference example images are stored in an example image database.

8. The method of claim 1, wherein the acquiring the representative input images comprises:
acquiring the representative input image for each input example set classified from the first input image based on the desired criteria.

9. The method of claim 1, wherein the acquiring of the representative input images comprises:
classifying a plurality of input example images similar to the first input image into n input example sets based on the desired criteria through clustering, n denoting a natural number greater than or equal to “1”; and
creating the n representative input images based on the input example images similar to the first input image that are retrieved from each reference example set.

10. The method of claim 9, wherein the creating comprises:
calculating a similarity between each of the n input example sets and the first input image, and determining m input example images having the similarity greater than a reference value, m denoting a natural number greater than or equal to “1”; and
creating the n representative input images using the m input example images.

11. The method of claim 1, wherein the desired criteria comprises a variation in a pose of a face or a variation in a lighting.

12. A non-transitory computer-readable medium comprising a program for instructing a computer to perform the method of claim 1.

13. A user authentication apparatus comprising:
a storage configured to store a first reference image of a user;
a communicator configured to receive first input image; and
a processor configured to acquire representative reference images classified from the first reference image based on desired criteria, to acquire representative input images classified from the first input image based on the desired criteria, and to authenticate the user based on a similarity between the first input image and the first reference image that is based on the representative input images and the representative reference images.

14. The user authentication apparatus of claim 13, wherein the processor is configured to calculate the similarity based on distances between features points of the representative input images and feature points of the representative reference images that correspond to each other based on the desired criteria.

15. The user authentication apparatus of claim 13, wherein the processor is configured to calculate the similarity based on a distance between a feature point of the first input image and a feature point of the first reference image and distances between features points of the representative input images and feature points of the representative reference images that correspond to each other based on the desired criteria.

16. The user authentication apparatus of claim 13, wherein the processor is configured to calculate the similarity based on a distance between a feature point of the first input image and a feature point of the first reference image, distances between features points of the representative input images and feature points of the representative reference images that correspond to each other based on the desired criteria, and a weight of each of the distances between the features points of the representative input images and the feature points of the representative reference images.

17. The user authentication apparatus of claim 13, wherein the processor is configured to classify a plurality of reference example images similar to the first reference image into a plurality of reference example sets based on the desired criteria through clustering, and to create the representative reference images based on reference example images similar to the first reference image that are retrieved from each reference example set.

18. The user authentication apparatus of claim 17, wherein
the reference example images include at least one of example images acquired from different poses of the user and example images acquired based on different lighting brightness, and
the storage includes an example image database configured to store the reference example images.

19. The user authentication apparatus of claim 13, wherein the processor is configured to classify a plurality of input example images similar to the first input image into n input example sets based on the desired criteria through clustering, n denoting a natural number greater than or equal to “1,” and to create the n representative input images based on the input example images similar to the first input image that are retrieved from each reference example set.

20. A user recognition method comprising:
acquiring representative reference images classified from each of a plurality of first reference images of users based on desired criteria;
acquiring representative input images classified from a first input image based on the desired criteria;
calculating a similarity between the first input image and each of the first reference images based on the representative input images and the representative reference images; and
recognizing a user corresponding to the first input image from among the plurality of users based on the calculated similarity.

21. The method of claim 20, wherein the calculating calculates the similarity based on a distance between a feature point of the first input image and a feature point of each of the first reference images and distances between features points of the representative input images and feature points of the representative reference images that correspond to each other based on the desired criteria.

22. The method of claim 20, wherein the calculating calculates the similarity based on a distance between a feature point of the first input image and a feature point of each of the first reference images, distances between features points of the representative input images and feature points of the representative reference images that correspond to each other based on the desired criteria, and a weight of each of the distances between the features points of the representative input images and the feature points of the representative reference images.

23. The method of claim 20, wherein the acquiring the representative reference images comprises:
acquiring the representative reference images for each reference example set classified from each of the first reference images based on the desired criteria.

24. The method of claim 23, wherein the acquiring of the representative reference images comprises:
classifying a plurality of reference example images similar to each of the first reference images into a plurality of reference example sets based on the desired criteria through clustering; and
creating the representative reference images based on reference example images similar to each of the first reference images that are retrieved from each reference example set.

25. The method of claim 24, wherein
the reference example images include at least one of example images acquired from different poses of each of the users and example images acquired based on different lighting brightness, and
the reference example images are stored in an example image database.
